(19) United States
(12) Patent Application Publication
(10) Pub. No.: US 2016/0044422 A1
(43) Pub. Date: Feb. 11, 2016

(54) Pointer System for Context Based Feedback

(71) Applicant: Dell Products, LP, Round Rock, TX (US)

(72) Inventors: Deeder M. Aurongzeb, Austin, TX (US); Rex W. Bryan, Round Rock, TX (US)

(21) Appl. No.: 14/456,176

(22) Filed: Aug. 11, 2014

(51) Int. Cl. H04R 17/04; G06F 3/041; G06F 3/0354

(52) U.S. Cl. CPC H04R 17/04; G06F 3/03545; G06F 3/0414

(57) ABSTRACT

Disclosed systems receive pointer input to an information handling system and determine the context for the user input. Characteristics of the input such as speed, acceleration, friction amount, and input pressure are analyzed. Disclosed systems tune audio data to provide dynamic audio feedback adjusted based on the analysis. Tactile feedback (e.g., the amount of friction between a stylus and interactive display) may be adjusted as needed to provide realistic or desired feedback to a user for a relevant context (e.g., handwriting, text highlighting, oil painting, etc.).

### FIELD OF THE DISCLOSURE

The present disclosure generally relates to input devices for information handling systems, and more particularly to a pointer system that provides feedback based on a context and pointer movement.

### BACKGROUND

As the value and use of information continues to increase, individuals and businesses seek additional ways to process and store information One option is an information handling system. An information handling system generally processes, compiles, stores, or communicates information or data for business, personal, or other purposes Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and email communication systems. Information handling systems can also implement various virtualized architectures. An information handling system may include an interface that receives user input through a pointer such as a finger or stylus.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 depicts aspects of a pointer for providing input to an information handling system according to an embodiment of the present disclosure;

FIG. 2 depicts aspects of a pointer system including a pointer and information handling system for receiving pointer input and providing context based feedback according to an embodiment of the present disclosure;

FIG. 3 depicts representative software based components of a pointer system used for providing pointer input according to an embodiment of the present disclosure;

FIG. 4 illustrates components of a pointer system for receiving pointer input and providing context based feedback according to an embodiment of the present disclosure;

FIG. 5 illustrates a flow diagram of a processor-based method for receiving pointer input and providing context based feedback according to an embodiment of the present disclosure;

FIG. 6 illustrates a flow diagram with further aspects of a processor-based method according to an embodiment of the present disclosure;

FIG. 7 illustrates a flow diagram with additional aspects of a processor-based method according to an embodiment of the present disclosure; and

FIG. 8 illustrates a block diagram with aspects of an information handling system according to an embodiment of the present disclosure.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings. The use of the same reference symbols in different drawings indicates similar or identical items.

Information handling systems have input systems for receiving user input. Input systems are used for entering data, making selections, and the like. Example input systems include a mouse, a keyboard, and an interactive display (e.g., touchscreen). In one scenario, a user provides input to an interactive display using a pointer. Example pointers include a finger, a stylus, or a digital pen. An example stylus is a pen-shaped cylinder with a rubberized tip. A stylus may be passive or include electronic systems (e.g., a location emitter) that work in conjunction with an information handling system for processing user input.

Information handling systems run applications or programs that receive and use pointer input. For example, a word processing program or a note taking program receives handwriting from users over an input system that includes a pointer and interactive display. In addition, handwriting may be entered within different contexts. Example contexts include pen to paper handwriting, pencil to paper handwriting, marker (e.g., highlighter) to paper handwriting, chalkboard handwriting, paint marker handwriting, and so on. Other non-limiting examples of contexts include erasing and painting on various surfaces such as dry erase boards, chalkboards, canvas, and the like. Each context can include a sub-context such as scribbling or sketching. Disclosed embodiments include pointer systems that provide user feedback that is appropriate for a particular context and tuned based on the type of user input provided. For example, for the context of pencil to paper handwriting, an embodied system would process user input to determine, for example, characteristics of the user input such as the speed, pressure, acceleration, and angle of a stylus used to provide the user input to an interactive display. In one scenario, user input is provided to a word processing program on an information handling system such as a tablet. An embodied system analyzes the user input and tunes or adjusts audio data to provide realistic feedback based on the context and the characteristics of user input (e.g., speed, pressure, etc.). If a user provides his or her signature using a stylus and an interactive display, an embodied system provides the user with realistic sounds emulating the user writing on paper with a pen. An embodied system with an active stylus can alter the amount of friction between a pointer and interactive display to provide further realistic feedback.

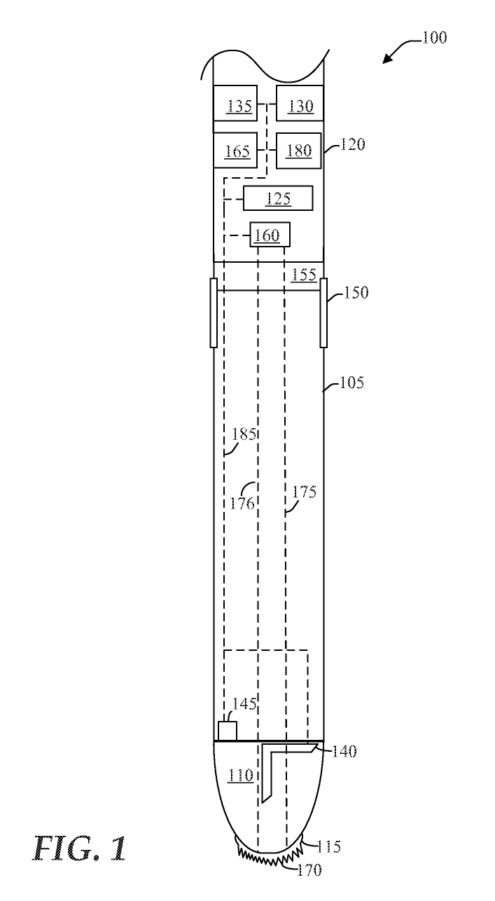

FIG. 1 depicts a cutaway view of a pointer 100 that includes a lower body 105, bottom portion 110, middle portion 155, and upper portion 120. Elements in the figures are not necessarily shown to scale. Bottom portion 110 may be comprised primarily of a piezoelectric material or may include a thin piezoelectric outer coating (e.g., zinc oxide, titanium oxide, etc.). In some embodiments, the piezoelectric material is transparent to radio frequency signals or includes an opening for emission of light (e.g., infrared) signals.

As shown, pointer 100 is an active stylus that includes processing unit 125, sound generator 130, and indicator 135. Indicator 135 may be an LED that provides information on the status (e.g., ON, OFF, etc.) of pointer 100. Processing unit 125 executes machine-readable instructions for providing user input and providing context based feedback in accordance with disclosed embodiments. Pointer 100 also includes communication unit 180. Communication unit 180 communicates directly with an information handling system using radio waves. Alternatively or in addition, communication 180 may transfer information and receive information indirectly over a network to the information handling system. As shown, processing unit 125 is communicatively coupled to sound generator 130, indicator 135, communication unit 180, transducer 145, location emitter 140, sensor 165, voltage course 160, and communication unit 180 over bus 185.

Transducer 145 senses parameters such as speed and pressure of input applied with pointer 100 to a display screen and provides data to processing unit 125. Processing unit 125, in some embodiments, executes machine instructions (e.g., software) to transmit the data over communication unit 180 to an information handling system, which in turn uses the data to tune sound data and provide audible feedback to a user. In other scenarios, pointer 100 provides audible feedback. Accordingly, transducer 145 sense pressure applied with pointer 100 to a display screen and provides the data to processing unit 125. Processing unit 125 in turn executes machine readable instructions to process the transducer data, to tune audio data based on the transducer data for a given context, and provide data to sound generator 130 to produce audible output based on the tuned data. As an example, transducer 145 detects a heavy pressure between pointer 100 and a display screen in the context of pencil-to-paper note taking. Processing unit 125 accesses and tunes audio data in a sound file representing a pencil writing on paper at an average or baseline pressure, and lowers the frequency for the sound to provide realistic feedback for the high contact pressure. In some embodiments, processing unit 125 lowers playback speed of an audio file to result in lower frequency. Processing unit 125 then provides the tuned data (e.g., a signal carrying encoded sound information to sound generator 130.

Location emitter 140 interacts with an interactive display on an information handling system. In some embodiments, location emitter 140 enables determining location in three dimensions, to permit an information handling system to determine the distance and location of the tip of pointer 100 relative to portions of an interactive display. Location emitter 140 may include a radio antenna or an infrared light emitting diode (LED). An information handling system receives and processes signals from location emitter 140 to determine the location of user input relative to an interactive display screen. Alternatively or in addition, processing unit 125 determines the relative location of pointer 100 to portions of the interactive display,

As shown in FIG. 1, pointer 100 includes contact surface 115. Contact surface 115 can be customized according to characteristics of a surface that pointer 100 is expected to contact. For example, if pointer 100 is expected to contact a glass display having a known roughness, contact surface 115 is selected or manufactured to have a matching or complementary roughness. As shown, contact surface 115 includes ridge 170 which is formed of a piezoelectric material that responds to input (e.g., a voltage) from electrodes 175 and 176. As shown, electrodes 175 and 176 are coupled to voltage source 160 (e.g., a battery). In the depicted embodiment, voltage source 160 raises or lowers a voltage applied to contact surface 115, which causes ridge 170 to increase or decrease in size through a piezoelectric effect. A piezoelectric effect relates to an interaction between the mechanical and electrical states of known piezoelectric materials. To the extent the piezoelectric effect is reversible in a material, contact surface 115 may include the material to allow changes in mechanical characteristics (e.g., a friction coefficient of the tip for a given surface and given pressure) of the pointer. Accordingly, a converse piezoelectric effect is used by causing voltage source 160 to apply a voltage across electrodes 175 and 176, which affects characteristics (e.g., roughness, hardness) of contact surface 115. As shown, contact surface 115 includes ridge 170. Ridge 170 changes its shape in response to the applied voltage. The size of ridges 170 can be increased or decreased by increasing or decreasing the applied voltage. As a result, the friction coefficient of pointer 100 can be adaptively changed to affect the friction between pointer 100 and an interactive display.

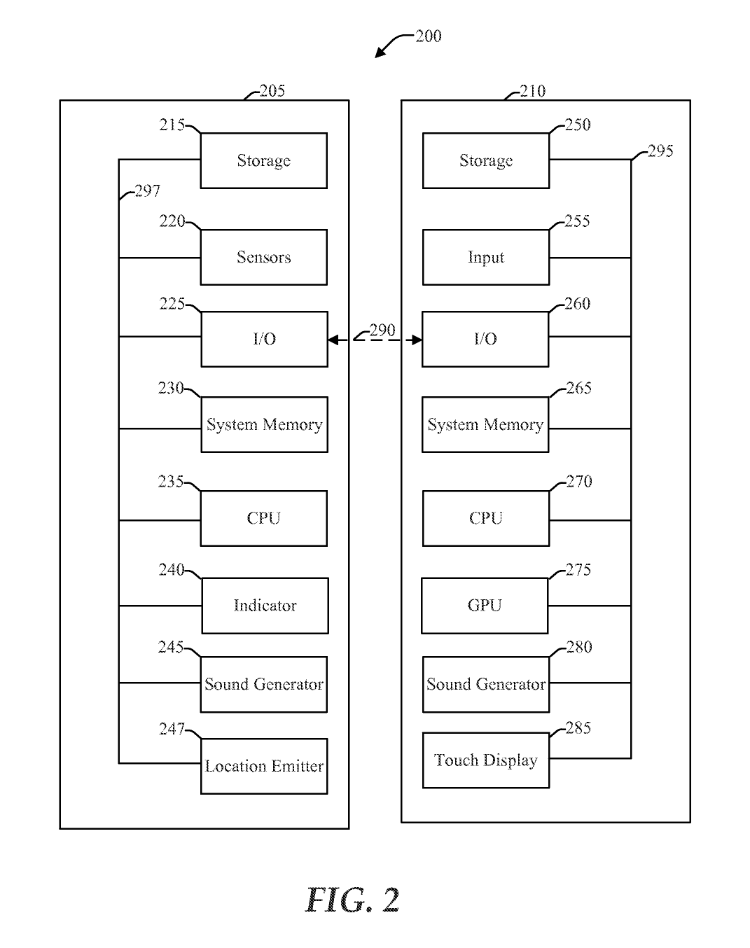

In this way, disclosed embodiments provide varied feedback to a user in response to a given use context (e.g., painting, handwriting, erasing). Alternatively, the degree of friction between a pointer and interactive display can be estimated based on interactions between the pointer and interactive display. For example, if a disclosed system detects that a stylus has slipped across an interactive display, an active stylus with a voltage source compensates and prevents future slippage by increasing the voltage applied to a piezoelectric tip to increase the friction between the stylus tip and interactive display (e.g., touch display 285 and FIG. 2).

Accordingly, pointer 100 can adjust its friction coefficient to provide realistic tactile feedback. Adjusting the friction coefficient can be in response to detecting slippage, detecting drag between pointer 100 and an interactive display, or otherwise performed in response to the context and characteristics of user input. As an example, the friction coefficient required for the context of writing with a ballpoint pen on paper could result in voltage source 160 providing a low voltage to contact surface 115 compared to the voltage applied to contact surface 115 for the context of writing with chalk on a chalkboard,

Ridge 170 as shown in FIG. 1 has an exaggerated size and is intended as representative of other similar ridges. Ridge 170 is microscopic in size in some embodiments. Regarding manufacturing procedures, a thermoplastic polymer can be mixed with oxide particles and subjected to injection molding to take the shape of bottom portion 110, contact surface 115, and ridge 170. To provide a contact surface 115 and ridge 170 that is ideal for providing tactile feedback when used in conjunction with another surface, the bottom portion can be pressed, for example, on a hot metal plate with ridges that form ridge 170, resulting in a contact surface 115 and ridge 170 that performs well (e.g., within a range of expected friction to realistically simulate anticipated contexts and anticipated pointer input) with the roughness of the material (e.g., glass, glass coated with protective plastic) of an interactive display. For example, contact surface 115 would be pressed into a hot metal plate with 20 μm ridges to match the roughness of a particular glass display that also was expected to have 20 μm ridges. In operation, pointer 100 adjusts voltage 160 to increase or decrease the friction coefficient of contact surface 115 with an interactive display. In this way, pointer 100 provides tactile feedback appropriate for a context and manner of use of pointer 100.

As shown in FIG. 1, pointer 100 includes an optional sleeve 150. Sleeve 150 can be made from a conductive material such as brass or copper in the depicted embodiment, and likewise lower body 105 may include a silver coating or metal based paint. For safety, upper portion 120 may be made in part from a polyimide or microban polymer. Bottom portion 110 in some embodiments forms a ceramic tip connected to lower body 105 through an adhesive bond (e.g., glue). Ridge 170 and contact surface 150 may be formed of, masked, or coated with a material having piezoelectric and dielectric properties similar to zinc oxide or titanium oxide. Upper portion 120, sleeve 150, lower body 105, and bottom portion 110 are coated with or made from antimicrobial elements in certain embodiments.

Pointer 100 includes transducer 145. Transducer 145, like other elements in the Figures, is shown in block diagram form for simplicity. Transducer 145 senses the pressure applied via pointer 100 to an interactive display surface in an information handling system. As shown, transducer 145 is communicatively coupled to processing unit 125 via bus 185. Data from transducer 145 is used to tune the sound of audible feedback provided to user. Example sound is recorded from an activity such as a pencil writing on paper to form a baseline for tuning. While recording the sound data, characteristics of the activity (e.g., the pressure, speed, and acceleration for a pencil or other writing implement) are captured and stored. If transducer 145 and other sensors detect a pointer is used in a way that corresponds to a certain sound for a context, sound data for the use characteristics is retrieved and refined (e.g., tuned to accurately fit the pointer use characteristics or tuned to have desired effects such as through filtering). Providing tuned audible feedback can occur in real time based on data from transducer 145, which may be processed using processing unit 125. If the user presses hard with pointer 100 on an interactive display in the context of writing using a pencil and paper, an embodied system customizes (e.g., tunes in real time) a sound meant to simulate writing with a pencil while digging into paper. Customization occurs generally as quickly as possible (e.g., in real time) by a processor executing code and receiving input from sensors, to realistically simulate the activity as it occurs. Pressing hard with pointer 100 and pressing lightly during one continuous stroke could result in transducer 145 providing varied pressure data used to customize a sound in real time. The result simulates a pencil making a stroke on a piece of paper with correspondingly varied levels of pressure applied between the pencil and paper.

Pointer 100 also includes sensor 165. Sensor 165 senses and provides data regarding the orientation, speed, and acceleration of pointer 100. Sensor 160 may include one or more gyroscopes for determining the orientation in the x-axis, y-axis, and z-axis compared to an interactive display. Similarly, sensor 165 includes accelerometers, gyroscopes, or similar components for detecting the speed and acceleration of pointer 100. An information handling system processes this information in real time to provide realistic, tunable, and audible feedback to a user based on one or more measured quantities regarding the speed, location, angle and acceleration of the pointer. The measured characteristics of pointer 100 are used differently depending on the context of a particular application. For example, if the context of user input is writing on a pencil with paper, the orientation of pointer 100 compared to an interactive display is used to provide realistic feedback based on a pencil used at a high angle (e.g., 90° angle between pointer 100 and an interactive display) or low angle (e.g., 30° angle between pointer 100 and the interactive display).

FIG. 2 illustrates aspects of hardware system 200 including pointer 205 and information handling system 210. Pointer 205 may be a stylus (e.g., pointer 100 in FIG. 1) and information handling system 210 may be a personal computer or tablet device.

Information handling system 210 receives user input from pointer 205 through touch display 285 or communication link 290. In some embodiments, CPU 270 implements an operating system and graphical user interface that receives input through pointer 205. CPU 270 may execute machine-readable code from storage 250 or system memory 265 to analyze input, to process the input, to determine a context for the user input, to determine appropriate audible or tactile feedback for the context based on the input, and to tune the audio data dynamically or cause tactile feedback (e.g., through contact surface 115 in FIG. 1).

Pointer 205 includes I/O unit 225, sound generator 245, and indicator 240. As shown, these hardware components are communicatively coupled via bus 297 to CPU 235 and other components. CPU 235 executes instructions to transmit data to sound generator 245, which causing sound generator 245 to provide audible output in accordance with disclosed embodiments. Sound generator 245 may operate similarly to sound generator 130 described above to receive tuned sound data and produce audible feedback based on the sound data. In this way, sound is generated from the pointer. Sound may also be generated from the sound generator (e.g., speaker) of an information handling system, or a sound generator of a display (e.g., touch display) for an information handling system.

Indicator 240 is an LED or other light source that provides status information, for example, regarding pointer 205. Location emitter 247 interacts with information handling system 210 to determine the location of pointer 205 on a grid or display. Location emitter 247 may emit infrared light, or cause a change in capacitance, that is detected by touch display 285, for example. CPU 235 executes machine readable instructions or code stored on storage 215 or system memory 230 to determine a context for user input, process user input, access audio data, tune the audio data according to the context and user input, and cause sound to be played from sound generator 245. In addition, CPU 235 (FIG. 2) may execute machine readable instructions to cause a voltage source (e.g., voltage source 160 in FIG. 1) to energize a piezoelectric material (e.g., contact service 115 in FIG. 1) to result in tactile feedback based on a context and user input using pointer 205 (FIG. 2). In some embodiments, sensors 220 include an accelerometer, gyroscopes, pressure detectors, and other such components to provide data to CPU 235 or CPU 270 to determine the orientation and status of pointer 205.

For purpose of this disclosure, information handling system 210 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 210 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 210 can include processing resources for executing machine-executable code, such as CPU 270, a programmable logic array (PLA), an embedded device such as a System-on-a-Chip (SoC), or other control logic hardware. As shown, information handling system 210 includes CPU 270, which could take the form of any such processing resource for executing code.

Information handling system 210 can also include one or more buses (e.g., bus 295) operable to transmit information between the various hardware components. As shown, information handling system 210 includes graphics processing unit (GPU) 275. GPU 275 processes data for display on a touch display. Sound generator unit 280 (e.g., a speaker, a piezoelectric speaker, flat panel speaker, electrostatic speaker, diaphragm speaker) provides audible feedback in accordance with some disclosed embodiments.

Information handling system 210 can also include one or more computer-readable medium for storing machine-executable code, such as software or data. For example, information handling system 210 includes storage 250 that may include executable code for processing input data received from pointer 205 over link 290. System memory 265 may be used by CPU 270 and GPU 275 while running executable instructions. Additional components of information handling system 210 can include one or more storage devices (e.g., memory chips) that can store machine-executable code, one or more communications ports for communicating with external devices, and various input and output (I/O) devices, such as a radio, keyboard, a mouse, and a video display.

As shown in FIG. 2, input unit 255 processes input from elements such as a pointer, a keyboard, a mouse, or a touchpad. Touch display unit 285 also processes input received through a pointer. For example, pointer 205 may include an infrared LED emitter or antenna that provides a signal used by touch display unit 285 to determine the location of pointer 205 relative to a coordinate system for the touch display.

CPU 235 executes code from storage 215 to tune audio data in real time to realistically emulate conditions associated with the use of pointer 205. This tuning can be done based on the context of the use of pointer 205. For example, information handling system 210 runs a software application that permits handwriting by a user input to touch display 285 via pointer 205. Touch display unit 285 present a graphical representation of a piece of paper. Pointer 205 is used to provide handwriting input, and audio output unit 245 or audio output unit 280 provides realistic sound output that is change dynamically based on data provided by sensors unit 220 related to various characteristics of user input (e.g., speed, acceleration, proximity to ouch display, and pressure exerted by pointer 205).

As shown, CPU 235 executes instructions from system memory 230 that are stored on storage 215. In some embodiments, storage 215 or 250 includes a gesture database. The gesture database includes in some embodiments sounds associated with various pointer gestures. The gesture database is also for storing data associated with certain the may be detected by a camera, for example. Example gestures include tapping, writing, scribbling, and erasing. Embodied systems dynamically tune audio data based on characteristics of user input and the context in which the user input is provided. For example, the pitch or amplitude of audible feedback is changed depending upon the input pressure, speed, acceleration, orientation, or location of pointer 205.

In accordance with disclosed embodiments, storage 250 or storage 215 may be used for storing audio files. For example, a microphone can be used to capture the sound of a pencil dragging across a piece of paper at various speeds and angles. Sound data is accordingly captured and sound files are stored in storage 250 for later access and possible tuning by disclosed embodiments. If a disclosed embodiment detects that a user is running a handwriting application that simulates a pencil writing on paper, one or more audio files in storage 250 are accessed by software running on CPU 270. Such audio files are part of a database stored locally or remotely (e.g., in the Cloud). For a particular context such as writing on paper with a pencil, an embodied database would include, for example, an audio file for slow speed writing on paper with a pencil, an audio file for medium speed writing on paper with a pencil, and an audio file for high-speed writing on paper with a pencil. An embodied system detects the speed (e.g., medium speed writing) at which the user input is provided through a pointer, accesses a corresponding audio file (e.g. an audio file recorded by a pencil writing on paper medium speed), and performs further tuning to the audio file, such as by increasing or decreasing the playback speed of the audio file.

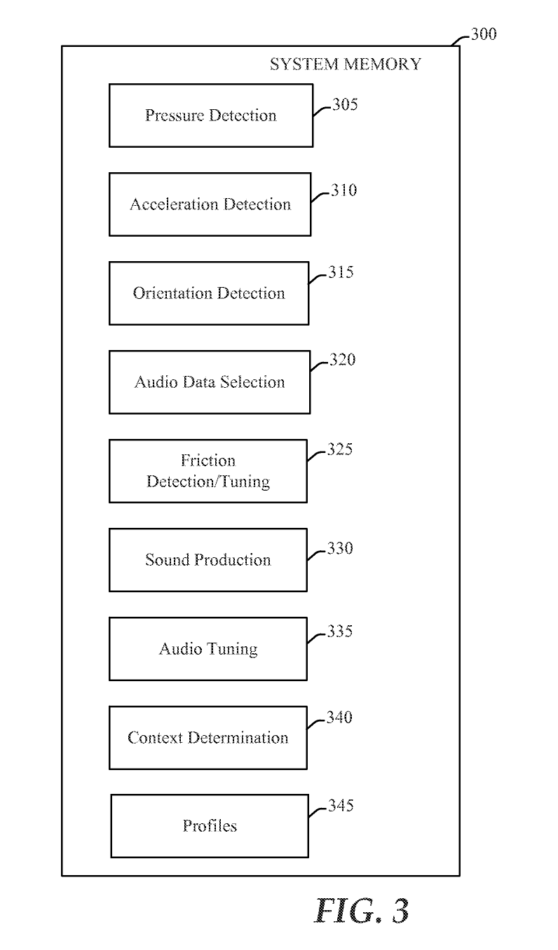

FIG. 3 depicts machine readable code, instructions or routines resident in system memory 300 in embodied systems. System memory 300 may correspond to system memory 265 (FIG. 2) associated with information handling system 210 (FIG. 2). Alternatively or in addition, system memory 300 corresponds to system memory 230 (FIG. 2). In this way, either a traditional data handling system (e.g., a computer) or an active stylus associated with the data handling system can be enabled for processing input information and providing tuned feedback in accordance with disclosed embodiments. In some embodiments, some elements represented in FIG. 3 are performed onboard a pointer (e.g., pointer 205 and. FIG. 2) while others are performed by a separate information handling system (e.g., information handling system 210 in FIG. 2).

As shown in FIG. 3, pressure detection module 305 receives and processes pressure data related to the contact pressure between, for example, pointer 205 (FIG. 2) and an interactive display from information handling system 210 (FIG. 2). This pressure data may be sensed by transducer 145 (FIG. 1). Acceleration detection module 310 processes acceleration data associated with a pointer (e.g., pointer 205 in FIG. 2). Such acceleration data may be provided by sensor 160 (FIG. 1). Orientation detection module 315 processes gyroscope data to detect the orientation of a pointer (e.g., pointer 205 in FIG. 2) in three dimensions. Audio tuning module 335 dynamically changes sound characteristics (e.g., pitch, frequency, amplitude) based on data provided by pressure detection module 305, acceleration detection module 310, and orientation detection module 315.

Context determination module 340 determines a context for user input such as handwriting on a chalkboard. Acceleration detection module 310 may likewise determine that a pointer (e.g., pointer 205 in FIG. 2) is accelerating rapidly. Audio tuning module 335 customizes or tunes sound data (associated with writing with chalk on chalkboard) to realistically provide sound that would be expected by moving chalk across a chalkboard with the speed, pressure, and motion of user input provided through a pointer on a touch display. In an embodiment, the tunable sound data is stored in storage 215 (FIG. 2) or storage 250 (FIG. 2). If the speed of a pointer is high, audio tuning module 335 (FIG. 3) increases the frequency of resultant sound. If the speed of the pointer is low, audio tuning module 335 decreases the frequency of resultant sound.

Context determination module 340 determines the context of user input which is related to the nature of a program or application running on information handling system 210 (FIG. 2). In one scenario, if a note-taking program running on information handling system 210 (FIG. 2) causes context determination module 340 (FIG. 3) to determine a context is handwriting on paper with a pencil. Other example contexts include map marking, snipping, drawing graphs, crossing out, character writing, planar drawing, scribbling on paper, drawing on paper, and highlighting. Audio data selection module 320 accesses sound data associated pencil handwriting on paper and sound production module 330 plays accessed files from a speaker or other sound generator after tuning to simulate the sound a pencil makes when dragged across a page.

Similarly, if context determination module 340 determines that the current context is highlighting with a marker, audio tuning module 335 alters the sound provided by sound unit 330 based on speed, pressure, location, and proximity information (or other such characteristics of user input) provided by pressure detection module 305, acceleration detection module 310, and orientation detection module 315. The sound can be altered or tuned by changing the pitch, frequency, or amplitude of the sound to match the input provided using the pointer. In some embodiments, this is achieved by reducing or increasing the playback speed of an audio file.

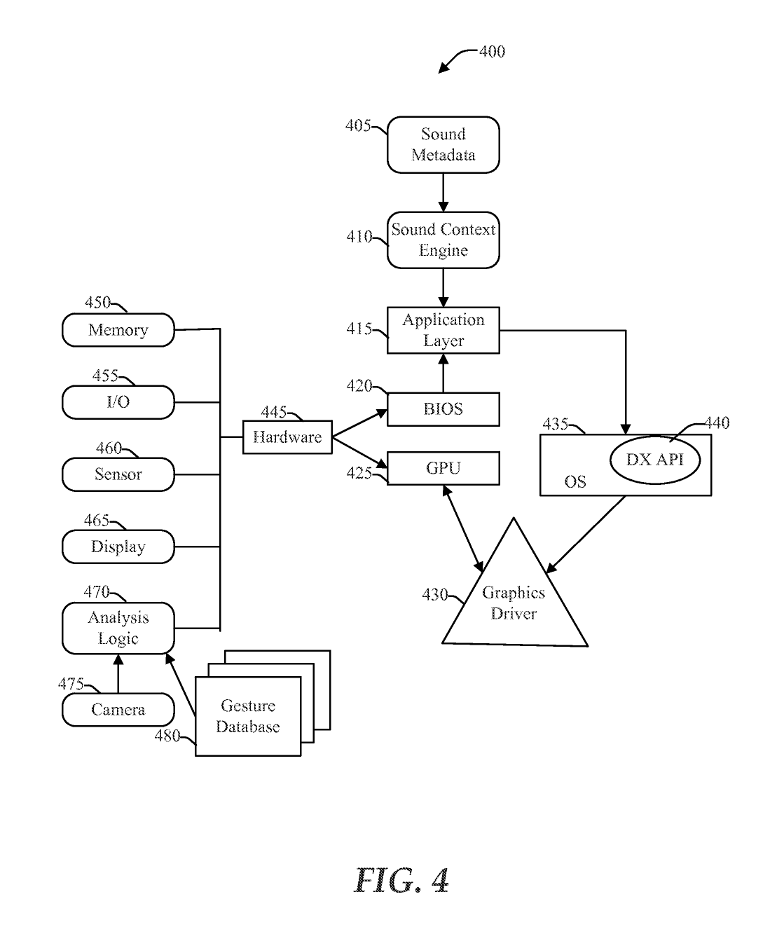

FIG. 4 illustrates a system 400 for providing context based feedback based on pointer input in accordance with disclosed embodiments. Hardware 445 represents hardware components typically associated with an information handling system such as a desktop computer. As shown, system 400 further includes memory 450, I/O 455, sensor system 460, display system 465, and analysis logic 470. Hardware 445 operates in conjunction with BIOS 420 and graphics processing unit (GPU) 425.

GPU 425 interacts with graphics driver 430 for providing graphical feedback (e.g., lines displayed on the screen, highlighting, etc.) to a user and receiving input from a pointer operated by a user against or proximate to an interactive display. For example, touch display 285 (FIG. 2) receives input from pointer 205 (FIG. 2) that is processed using graphics driver 430. In response to the user input, graphics driver 430 and graphics processing unit 425 provide visual feedback (e.g., a line) to the user. In accordance with disclosed embodiments, system 400 provides tuned audio output and tuned tactile output to a user, in addition to providing visual feedback to the user. The tuned audio output and tuned tactile output may be provided in real time and changed dynamically to provide a realistic experience for the user based on a particular context. For example, system 400 provides a user that uses a stylus to simulate writing notes on paper using a pencil a dynamically changing, tuned experience that simulates the sound and friction between the pencil and paper according to what the user would expect based on the acceleration, speed, angle, and pressure applied between the pointer and the interactive display.

In FIG. 4, application layer 415 represents the layer at which applications operate within an information handling system. For example, a note taking application (e.g., an application in which a user writes on an interactive display with a stylus to simulate handwritten notes using a pencil on a piece of paper) is operated from the application layer 415. Similarly, a painting application (e.g., an application in which a user uses a stylus pointer to simulate painting with a paintbrush on a simulated canvas) is operated from application layer 415. Sound context engine 410 determines for the input and application a context (e.g., handwriting, note taking, scribbling, scratching, erasing, painting, etc.), and determines or accesses the corresponding sounds. Sound metadata 405 includes data associated with stored sounds, such as speed, acceleration, surface, and pressure used for recording sound data. Sound metadata 405 relates to sound files stored on a data source which may be local to or remote from hardware 445. Such data sources may be a combination of local and remote sources. Accordingly sound metadata 405 may be stored (e.g., in memory 450) or accessed from a remote source over a network.

Sound context engine 410 accesses relevant sound, graphics, and tactile data used by an application running on application layer 415 to provide realistic and dynamic feedback to a user in response to user input from a pointer to an interactive display. Data objects (e.g., sound data files) are stored remotely or locally and, in accordance with disclosed embodiments, can be added to, modified, or deleted to suit the requirements of a user for the context of the application. DX API 440, which is part of operating system 435, interacts with commands from graphics driver 430 to access interface functions related to receiving user input from a pointer and providing visual feedback to a user (e.g., a graphical line of varied width, with the width based on the pressure received at the interactive display).

Gesture database 480, camera 475, and analysis logic 470 interact together for receiving user input. Camera 475 captures pointer movements and analysis logic 470 accesses gesture database 480 to determine a gesture that corresponds to the captured movements. Sound context engine 410 may use the gesture to determine the context. The input may be from a pointer such as a human hand, passive stylus, or active stylus. Sensor unit 460 receives transducer input such as pressure or location input received at display 465. I/O 455 allows communication between system 400 and an external pointer (e.g., pointer 100 in FIG. 1 or pointer 205 in FIG. 2) in accordance with disclosed embodiments,

In one scenario, sound context engine 410 determines the context for user input provided via a stylus. This determination is made upon launching an application, for example. Analysis logic 470 determines whether a stylus is active within a given application based on the measured proximity of a stylus to an interactive display. If the stylus is active, such as by simulating writing on the interactive display for a pencil on paper context, a default sound for the given conditions is accessed and played from a digitizer after tuning. In an embodiment, analysis logic 470 includes instructions for determining whether a digitizer enabled touch pixel is above or below a set value (e.g., a threshold). If the digitizer enabled touch pixel is above or below the set value, then analysis logic 470 changes the pitch of the sound played from the digitizer by raising or lowering the pitch for an accurate depiction of the expected sound given the characteristics of stylus input. In addition, the sound level (i.e., amplitude) of the sound may be increased or decreased according to the measured conditions of stylus input.

When writing in a context involving handwriting using pencil to paper, the pressure applied between the stylus and interactive display can be used to vary the sound based on its amplitude. For example, an increase in pressure applied to the stylus results in increased sound amplitude. In one scenario, the speed and acceleration of the stylus correlates to tuning based on changing the pitch and frequency of sound. Accordingly, amplitude tuning is performed based on the pressure applied between the stylus and interactive display. In contrast, frequency tuning is performed according to the speed and acceleration of the stylus.

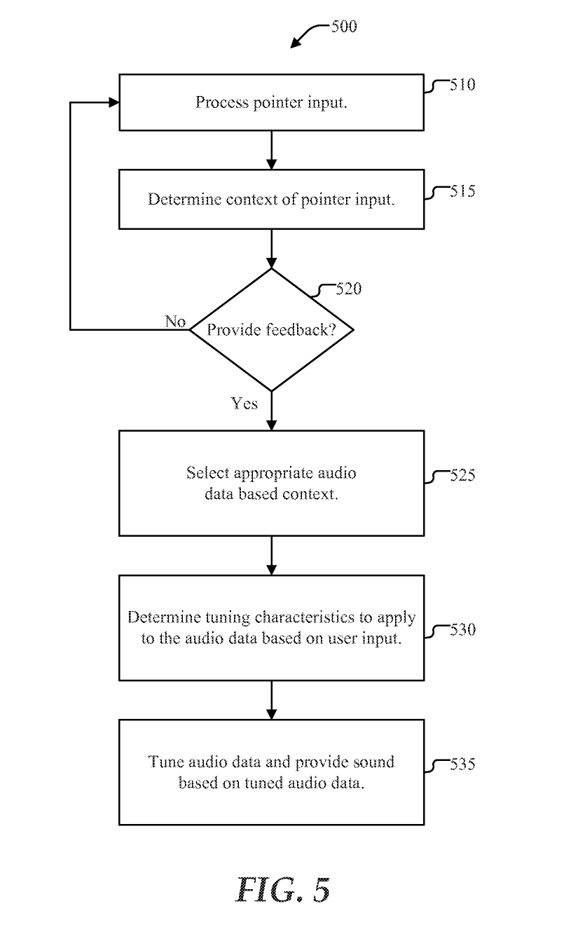

FIG. 5 is a flow diagram of a method 500 for tuning sound data associated with input provided through a pointer (e.g., pointer 205 and FIG. 2) to a data handling system (e.g., data handling system 210 in FIG. 2) in accordance with disclosed embodiments. Method 500 may be performed by a processor (e.g. CPU 270 or CPU 235 in FIG. 2) executing machine readable instructions stored on a tangible medium such as a memory (e.g., storage 215 or storage 250 in FIG. 2). Accordingly, each of the blocks in method 500 typically corresponds to software code executed by processor.

At block 510, pointer input is processed. Pointer input can be derived from a transducer (transducer 145 in FIG. 1). In one scenario, transducer input includes pressure data and friction data associated with the amount of pressure and friction between a pointer and a touch display. Block 515 relates to determining the context of the pointer input. The context of the pointer input is derived from the type of program or application running on an information handling system that is receiving input from the pointer. Each application that runs on in information handling system in conjunction with an interactive display and stylus may include a flag, pointer, or data field designating its context. If the context of the stylus input requires feedback, block 520 includes proceeding to block 525 to access appropriate sound data based on the stylus input and context. For example, block 525 includes accessing sound data associated with writing on a chalkboard if block 550 determines the context of the stylus input is the virtual (i.e., simulated) act of writing on chalkboard. If the stylus input in block 525 indicates a user is tapping as opposed to writing, block 525 includes accessing sound data associated with tapping on chalkboard with chalk rather than writing on a chalkboard. Context information stored for an application may include data related to both the writing surface and instrument used to write on the surface.

Block 530 relates to determining the tuning characteristics to apply to the sound based on the context of the pointer usage and the characteristics of pointer input. If the pointer input is provided rapidly (e.g., by moving the pointer rapidly across an interactive touch display on the information handling system), block 530 typically increases the frequency for the sound data. Block 535 relates to providing a tuned sound based on the pointer input and context. Block 535 may include providing a signal to a speaker to emulate the sound a piece of chalk makes when applied to a chalkboard. If block 530 calls for increasing the frequency of a resultant sound, block 535 may increase the playback speed to result in a higher frequency. Alternatively, block 530 may apply digital processing to sound data to result in a realistic sound based on stylus input. For example, effects such as time stretching, pitch shift, and others may be applied by a CPU executing software, as discussed herein, to result in realistic tuning sound based on user input.

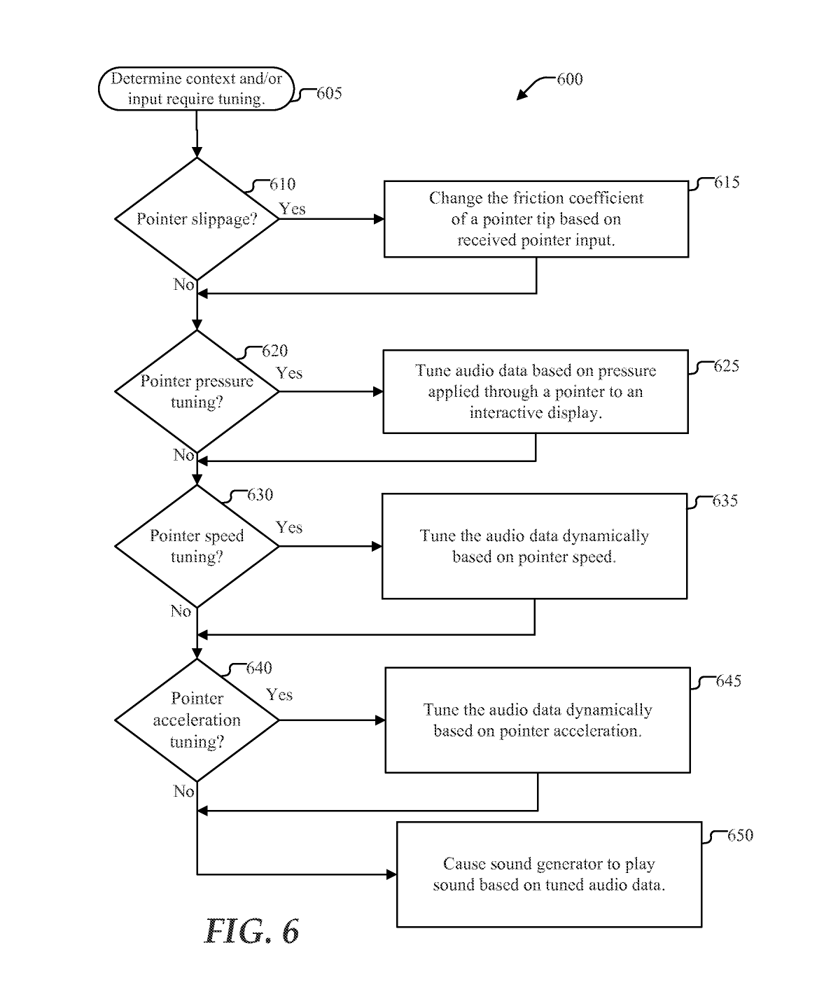

FIG. 6 illustrates a processor-based method for receiving and processing pointer input. An example system that performs process 600 (FIG. 6) is illustrated in FIG. 2. As discussed with respect to FIG. 2, information handling system 210 interacts with pointer 205 over communication link 290 to receive and process pointer input.

As shown, block 605 relates to determining that a particular context or pointer input requires tuning such as audio tuning or tactile tuning. Information handling system 210 (FIG. 2) can perform block 605 in the context of a computer program run by CPU 270 (FIG. 2) by accessing, for example, a flag or variable associated with the context of a particular computer program or task executed within a computer program. For example, if CPU 270 (FIG. 2) is running a simulated painting application, CPU 270 (FIG. 2) can access a field or flag associated with context of the painting application to determine whether it may be subject to tuned audio or tactile feedback. If the application running on information handling system is one that relates to providing tuned audio feedback, process 600 proceeds through the additional blocks to determine the type of tuning to apply based on the characteristics of the input received and the context,

At block 610, an optional determination is made whether any pointer slippage or pointer drag requires adjustments to the friction coefficient of a pointer. Alternatively, a change in the context or style of input may require a change in the friction coefficient of a pointer. For example, if the user switches from a context associated with pencil writing on paper to a context associated with painting on a canvas, the friction coefficient of the pointer is changed in block 615 to more closely match that of a paintbrush on canvas. Drag occurs if there is too much friction between a pointer and an interactive video screen, for example. Pointer slippage occurs when there is not enough friction between a pointer and an interactive video screen. In accordance with disclosed embodiments, an active stylus, for example, may increase the friction between the stylus point and interactive video screen by use of piezoelectric materials at the end of the stylus, where contact is made with interactive video screen. Adjusting a voltage to the piezoelectric material making up the pointer tip causes ridges to increase or decrease in size, which results in a change of the tip's friction coefficient. Accordingly, the level of slippage or drag between a pointer and interactive video screen can be adjusted using a varied voltage applied within an active pointer. Accordingly, if an embodied system determines in block 610 that there has been pointer slippage (or excessive pointer drag), block 615 performs changing the friction coefficient of a pointer based on received pointer input. The friction coefficient can also be changed based on the context. If the context of the running application executed on an information handling system relates to a pencil dragging on paper, the friction coefficient between the stylus and interactive display would be adjusted using the active piezoelectric system within the stylus to create a realistic feedback for the user in block 615. Alternatively, if the context relates to painting with a paintbrush on a canvas, block 615 involves adjusting the voltage applied to a piezoelectric material to emulate the level of friction expected between a paintbrush and canvas.

Block 620 relates to determining whether an amount of pressure between a pointer and an interactive video screen requires tuning audio based on a changed or changing pressure. An interactive video screen may include transducers that sense the amount of pressure between the video screen and pointer. An active pointer (e.g., an active stylus) may include sensors (e.g., transducer 145 in FIG. 1) to determine the amount of pressure between the pointer and interactive video screen. Block 625 relates to tuning audio data based on a pressure applied through a pointer to an interactive display. For example, if the context of pointer input is simulating a pencil writing on paper, tuning the audio in accordance with block 625 relates to simulating a pencil sound on paper for varied levels of pressure. The frequency of stored audio data related to the context of pencil-paper writing is lowered for high pressure between the pointer and interactive display. Lower levels of pressure in block 625 result in tuning to simulate the sound made by light pressure between a pencil and paper. Such tuning is performed by accessing audio data stored for lightly applied pressure from a pencil or changing the playback speed (e.g., to change the playback frequency) of baseline audio data.

Block 630 relates to determining whether pointer speed parameters warrant tuning of audio data. For example, if pointer speed is fast and the context is writing between a paper and pencil, audio data is tuned to simulate fast writing between a pencil and paper. For example, CPU 270 (FIG. 2) executing machine readable instructions stored on storage 250 (FIG. 2) accesses audio files stored in storage 250 (FIG. 2) and increases the playback speed to result in a higher frequency sound emanated from sound generator 280 (FIG. 2) or sound generator 245 (FIG. 2).

Block 635 relates to tuning the audio dynamically based on pointer speed. Tuning the audio dynamically relates to tuning the audio data in real time or substantially real-time as measured parameters based on pointer input change. In the example system of FIG. 2, block 635 is performed using sensors 220 to detect the speed and orientation of pointer 205. The speed is communicated over communication link 290 to CPU 270. Based on the input, computer code executed by CPU 270 and stored on storage 250 determines whether a detected speed of a pointer corresponds to the feedback being provided to a user over sound generator 280 or sound generator 245. If an adjustment is needed to tune the result for realistic feedback, CPU 270 tunes the audio data to fit the input received from sensors 220.

In FIG. 6, block 640 relates to determining whether pointer acceleration tuning is required. Pointer acceleration tuning may be required if an accelerometer within a pointer (e.g., an active stylus) detects acceleration of the pointer tip has occurred. Alternatively, an interactive display includes sensors or transducers to detect when acceleration of the pointer is occurring. As an example, sensors 220 (FIG. 2) include an accelerometer (e.g., acceleration detection unit 310 in FIG. 3) that detect when pointer 205 is accelerating across the surface of an interactive display (e.g., touch display 285 in FIG. 2).

In block 650, disclosed systems cause a sound generator to play sound based on tuned audio data. For example, in an embodied system based on components from FIG. 2, the tuned sound is played sound generator 2.45 or sound generator 280. The sound is tuned according to disclosed embodiments by, for example, dynamically processing sound data, dynamically accessing separate sound files for various pointer input scenarios (e.g., a measured speed, a measured acceleration, etc.), or adjusting the playback speed for sound data. For example, increasing the playback speed for sound data causes an increase in the frequency of generated sound. In contrast, decreasing the playback speed for sound data causes a decrease in the frequency of the generated sound.

In some embodiments, a CPU within an active stylus performs processor-based functions disclosed in FIG. 6. For example, pointer 205 (FIG. 2) includes CPU 235 which has access to storage 215. Within storage 205 (FIG. 2) are audio files related to certain contexts (e.g., writing, erasing, painting, etc.) and input parameters (e.g., changing input pressure, changing writing speed, acceleration of writing speed, etc.).

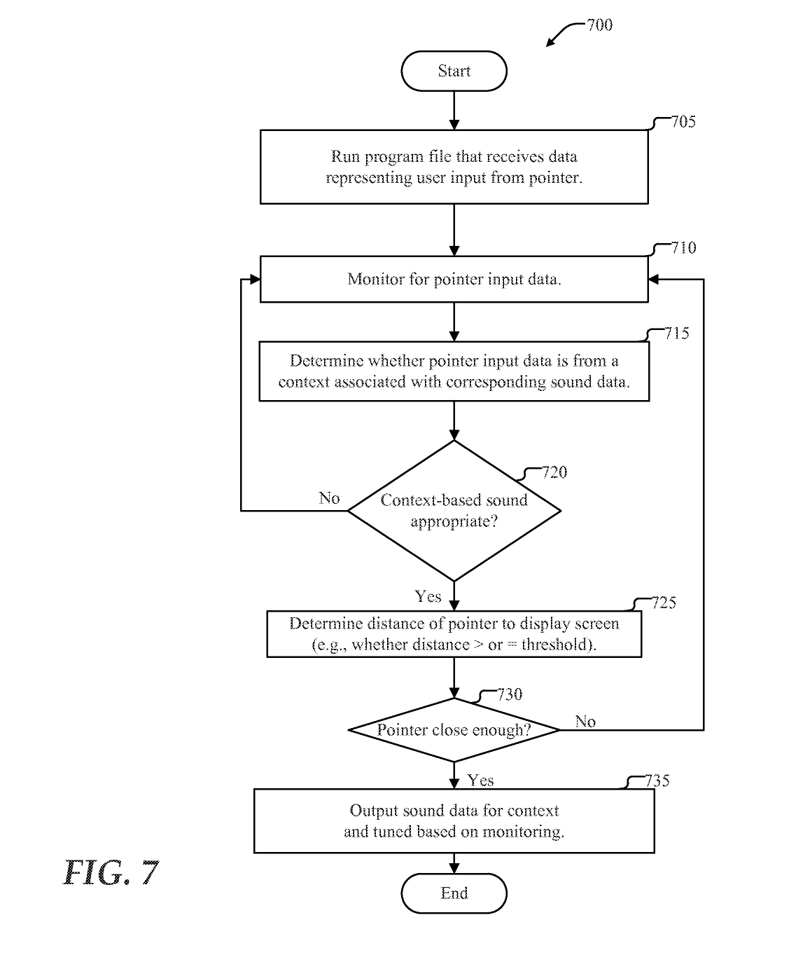

FIG. 7 is a flow diagram of method 700 for providing audible feedback associated with pointer input in accordance with disclosed embodiments. Method 700 may be performed by a processor (e.g., CPU 235 or CPU 270 in FIG. 2, processor 125 in FIG. 1) executing machine readable instructions stored on a tangible medium such as a memory (e.g., storage 215, storage 250, system memory 230, system memory 265 in FIG. 2). Accordingly, each of the blocks in method 700 may correspond to software code executed by processor.

Block 705 relates to running a program file that receives data representing user input from a pointer such as the stylus. As an example, a note taking application is run by an information handling system (e.g., information handling system 210 in FIG. 2). In one scenario, the note taking application simulates a user writing on a piece of paper, as the user operates a stylus near or against a touch display on which a virtual piece of paper appears. Block 710 relates to monitoring for pointer input data. For example, touch display unit 285 (FIG. 2) determines whether pointer 205 is proximate to or touching its display. In an embodiment, emitter 140 (FIG. 1) provides radio signals or infrared light signals detected by the display unit during the monitoring of block 710. Block 715 relates to determining whether pointer input data is from a context associated with corresponding sound data. In an embodiment, CPU 270 (FIG. 2) executes machine instructions to determine whether a running program is associated with a context having corresponding sound data. In one scenario, if the user is browsing a webpage, and dragging a stylus along a screen to scroll through the webpage, block 715 determines that the context is not associated with corresponding sound data. Storage 250 (FIG. 2) includes data (e.g., a flag) accessed by CPU 270 (FIG. 2) during the operation of the web browser that mandates that no sound data is associated with the context. Accordingly, method 700 includes cycling back via block 720 to block 710 to repeat monitoring for pointer input data. In contrast, if in block 715 it is determined that the input data is from a context associated with corresponding sound data, block 720 includes proceeding to block 725 to determine if the pointer proximity exceeds a threshold for providing sound output. For example, if in block 715 it is determined that a handwriting application is being used, and the associated context is handwriting, block 725 determines the proximity of a pointer to a display screen. If it is determined that the pointer is within a threshold (e.g., centimeter) of a touchscreen, block 730 determine the pointer is close enough to result in the output of sound data in block 735. If not, block 730 includes cycling back to block 710 to monitor for further stylus input data. Block 735 includes outputting sound data for a current context, where the sound data is tuned based on the monitoring of the stylus input data.

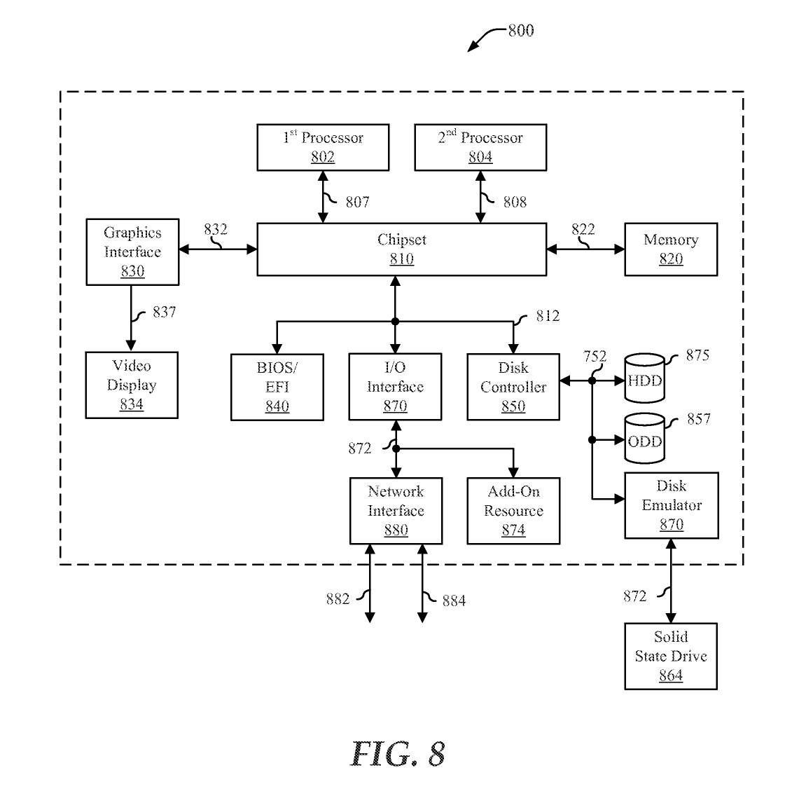

FIG. 8 illustrates a generalized embodiment of information handling system 800. Information handling system 800 can include devices or modules that embody one or more of the devices or modules described above, and operates to perform one or more of the methods described above. Information handling system 800 includes a processors 802 and 804, a chipset 810, a memory 820, a graphics interface 830, include a basic input and output system/extensible firmware interface (BIOS/EFI) module 840, a disk controller 850, a disk emulator 860, an input/output (I/O) interface 870, and a network interface 880. Processor 802 is connected to chipset 810 via processor interface 806, and processor 804 is connected to chipset 810 via processor interface 808. Memory 820 is connected to chipset 810 via a memory bus 822. Graphics interface 830 is connected to chipset 810 via a graphics interface 832, and provides a video display output 836 to a video display 834. In a particular embodiment, information handling system 800 includes separate memories that are dedicated to each of processors 802 and 804 via separate memory interfaces. An example of memory 820 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 840, disk controller 850, and I/O interface 870 are connected to chipset 810 via an I/O channel 812. An example of channel 812 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 810 can also include one or more other I/O: interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EH module 840 includes BIOS/EFI code operable to detect resources within information handling system 800, to provide drivers for the resources, initialize the, and access the resources. BIOS/EFI module 840 includes code that operates to detect resources within information handling system 800, to provide drivers for the resources, to initialize the resources, and to access the resources.

Disk controller 850 includes a disk interface 852 that connects the disc controller to a hard disk drive (HDD) 854, to an optical disk drive (ODD) 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits a solid-state drive 864 to be connected to information handling system 800 via an external interface 862. An example of external interface 862 includes a USB interface, an IEEE 7194 (Firewire) interface, a proprietary interface, or a combination thereof. Alternatively, solid-state drive 864 can be disposed within information handling system 800.

I/O interface 870 includes a peripheral interface 872 that connects the I/0 interface to an add-on resource 874 and to network interface 880. Peripheral interface 872 can be the same type of interface as I/O channel 812, or can be a different type of interface. As such, I/O interface 870 extends the capacity of I/O channel 812 when peripheral interface 872 and the I/O channel are of the same type, and the I/O interface translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as chipset 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Accordingly, a system is described in which a pointer provides input through a user interface for an information handling system (e.g., a desktop computer). The user interface may be presented through an operating system or application running on the information handling system. An application (e.g., a computer program) receives and processes user input provided through the pointer. In accordance with disclosed embodiments, the context associated with the application and the type of input received may both dictate the feedback provided to the user. For example, an application (e.g., computer program) may permit note-taking on a simulated chalkboard with chalk. Accordingly, the context in such a system would be chalk writing. A sub context may be identified as scribbling on a chalkboard. An embodied system receives user input from a pointer that is relevant to the context, and provides feedback (e.g., tactile feedback or audible feedback) that is tuned realistically and dynamically according to measured characteristics of the user input. For example, an embodied system may detect for a pencil-paper handwriting application that the relatively quick speed of a user's input requires increasing the playback speed for audio data associated with the context of pencil-paper handwriting

Although only a few exemplar embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for executing a computer program on a processor to provide feedback based on received pointer input, the method comprising:
determining a context for the pointer input;
selecting audio data corresponding to the context;
tuning the audio data based on the pointer input; and
providing sound based on the tuned audio data.

2. The method of claim 1, further comprising:
changing a friction coefficient of a pointer based on the received pointer input.

3. The method of claim 1, wherein tuning the audio data is based on a pressure applied through a pointer to an interactive display.

4. The method of claim 1, wherein tuning the audio data is performed dynamically based on at least a selected one of:
pointer speed; and
pointer acceleration.

5. The method of claim 1, wherein tuning the audio data comprises:
dynamically changing a speed of playback based on a speed of a pointer to affect a frequency of the provided sound.

6. The method of claim 1, wherein:
the provided sound simulates a sound of a writing utensil writing on paper.

7. The method of claim 1, wherein:
the provided sound simulates an eraser rubbed on paper.

8. An input system for an information handling system, the input system comprising:
a transducer for determining at least one characteristic of pointer input;
a sound generator; and
a processor programmed for:
tuning sound data based on the at least one characteristic of pointer input, wherein the sound data is for an input context;
causing tuned sound based on the tuned sound data to be played from the sound generator.

9. The input system of claim 8, wherein tuning the sound occurs substantially in real time based on the at least one characteristic of the pointer input.

10. The input system of claim 8, wherein the at least one characteristic of pointer input comprises a physical pressure applied through a pointer.

11. The input system of claim 9, wherein the at least one characteristic of pointer input is selected from:
a pointer speed; and
a pointer acceleration.

12. The input system of claim 8, further comprising:
an active stylus.

13. The input system of claim 12, wherein the active stylus comprises a sound generator.

14. The input system of claim 12, wherein the active stylus comprises a voltage source for affecting ridges on a piezoelectric tip.

15. An information handling system comprising:
an interactive display for dynamically receiving pointer input;
a processor enabled for:
determining a context of the pointer input;
determining a sound that is responsive to the pointer input for the context;
tuning the sound in response to the dynamically received pointer input; and
transmitting data causing sound generation to provide audible output based on the tuned sound.

16. The information handling system of claim 15, wherein tuning the sound comprises altering the frequency of the sound based on a measured speed of the pointer.

17. The information handling system of claim 15, further comprising:
a pointer comprising:
a gyroscope; and
an accelerometer.

18. The information handling system of claim 17, the pointer further comprising:
a sound generator for providing the audible output.

19. The information handling system of claim 18, wherein the pointer further comprises a transducer, wherein tuning the sound is in response to data from the transducer or in response to the dynamically received pointer input.

20. The information handling system of claim 17, wherein the pointer further comprises:
a location emitter;
a piezoelectric tip; and
a voltage source for applying voltage to the piezoelectric tip.
